(19) United States
(12) Patent Application Publication
(10) Pub. No.: US 2007/0177880 A1
(43) Pub. Date: Aug. 2, 2007

(54) Retromodulation-based data communication

(76) Inventors: Nir Karasikov, Haifa (IL); Michael Slatkin, Herzelia (IL); Amir Ben-Shalom, Modiein (IL); David Tamir, Haifa (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 10/598,910

(22) PCT Filed: Mar. 15, 2005
(86) PCT No.: PCT/IL05/00292

§ 371 Date: Sep. 14, 2006

Related U.S. Application Data
(60) Provisional application No. 60/552,728, filed on Mar. 15, 2004.
(60) Provisional application No. 60/600,811, filed on Aug. 12, 2004.

(51) Int. Cl. H04B 10/00

(52) U.S. Cl. 398/170

(57) ABSTRACT

A data communication system comprising a transceiver unit for retromodulated optical communication with at least one of a plurality of retromodulator units, the transceiver unit comprising at least one of a plurality of transceivers, the transceivers transmitting diffused radiant energy at different angles covering a predetermined three-dimensional area, wherein each transceiver is enabled to set up and execute communication with at least one retromodulator unit located within its coverage area. Furthermore, a retromodulator comprising multiple arrays of lenslets or spherically arranged lenslets is provided for achieving a wide angle of acceptance. Further more a number of novel applications based on the data communication system are provided, including a remote wireless network connection for a portable computing device, a smart card for remote wireless identification, remote data collection, and remote downloading of digital photographs.

### FIELD OF THE INVENTION

The invention relates to retroreflecting optical communication, more particularly to low energy multidirectional optical communication wherein an incident beam is modulated with a signal and retroreflected to communicate the signal to the beam source.

### BACKGROUND OF THE INVENTION

A retroreflector is an optical device that reflects an incident light beam back to the beam source. Light intensity modulators are a device that can change light transmission by applying electrical signals. Retromodulators combine these functions. Their use for communicating a signal by modulating the light beam with the signal is known.

Examples of retromodulated optical communication between an optical transceiver unit and a mobile retromodulator unit are disclosed in a number of prior art patents.

U.S. Pat. Nos. 4,731,879; 4,983,021; 5,909,299 are space applications.

U.S. Pat. No. 6,154,299 describes a high repetition rate retromodulator.

U.S. Pat. Nos. 5,355,241, 6,353,489; and 6,624,916 focus on friend or foe identification devices where a pre-stored modulation code is applied to the retromodulator. There is no sensing element related to the device and the modulation rate is usually low.

U.S. Pat. No. 5,606,458 is a HUD illumination system using retro

U.S. Pat. Nos. 6,233,088 and 6,507,441 also treat retromodulated communication.

US provisional patent application no. 60/552,728 and PCT no. WO0232150 by the authors of the current invention discloses a retroreflector incorporating a modulator.

A problem relating to retromodulating units used in prior art is the limited field of view, which requires optical alignment in order to realize the retro communication. It is a main object of the present invention to provide a retromodulated optical communication system and method incorporating a retromodulating unit with wide field of view while maintaining reduced power consumption both at the source and the retromodulation unit.

Another limitation of prior art is that it focuses on single line communication: one retromodulator to one transceiver. It is therefore a further object of the present invention to facilitate simultaneous communication between multiple mobile retroreflecting units and a single transmitting station.

It is desirable to minimize the level of energy emitted in the periods between communication sessions while maintaining the capability of the transmitting station to detect a retromodulator at any time that the transmitting station or the retromodulator wants to initiate a communication session. It is therefore another object of the present invention to provide means for using minimal radiated energy in the periods between communication sessions while maintaining communication session initiation detection.

It is another main object of the present invention to provide novel applications for a retroreflecting optical communication system and method.

One such application is the use of infrared (IR) communication for portable computing devices. Many portable devices have IR communication ports, including personal digital assistants, portable computers, and cellular telephones. Since these IR-enabled devices are portable, they are battery-powered, making it important that the IR port is efficient in its power consumption, to avoid having to change or charge the device's batteries.

Current IR ports comprise one or more IR diodes mounted in the portable device and used to transmit information using a communication protocol. Such a means of transmitting is adequate for occasional use but, as IR transmission typically uses up current on the order of milliamps, frequent use of the port may be expected to increase the need for battery charges. Battery capacity thus acts as a limitation on the freedom of applications to make full use of the IR port.

A challenge in constructing a retromodulation-enabled portable device is to provide the retromodulator with a wide enough acceptance field of view that it can retroflect incident radiation from transceivers situated anywhere in a predetermined three-dimensional area around the device, where that area may extend as far as to comprise the complete 360 degrees of surrounding space.

It is therefore another main object of the present invention to provide to provide an IR interface with a wide acceptance field of view to a wireless fidelity (WiFi) network.

Another application of the current invention is as a remote controller. Current remote controllers utilize LEDs, which actively irradiate light toward a receiver in the controlled device, such as television and modulate the light with control information. Most of the battery energy is spent on the light emission. The frequent need to change batteries in such controllers is inconvenient.

It is therefore another main object of the present invention to provide to provide a retromodulator-enabled controller with very low battery power consumption.

Another application of the present invention is in a smart card for access to restricted areas. The protection of public places today is done by a security guard with a metal detector at the gate. There have been cases where the guard was unable to remotely detect a suspicious person, culminating with a fatal attack taking the lives of the guard as well as many innocent citizens. A remote and early detection provision would give a few extra critical seconds, in which the guard can act and prevent the terrorist attack.

A smart card could be used for remote validation via transmission of the holder's biometric features for routine access control to institutions or special events. A few examples are: hospitals, restricted zones in airports, and convention centers.

Such a smart card could further contain stored biometric information on the holder for comparison. The new US requirements for a visa with biometric validation is an example of use for such a smart card. Such smart cards could contain the card holder's essential identification data as well as biometric characteristic information such as a coded fingerprint, a voice formant or some invariant morphometric feature.

It is therefore another main object of the present invention to provide to provide a smart card for remote identification, the card optionally providing means for recording and communicating biometric information about the card holder and optionally storing such information for comparison.

Another application for the present invention is data collection from miniature objects such as nanorobots or MAVs (micro aerial vehicles) where communication consumes energy and battery volume and an introduction of low power IR communication can be extremely beneficial.

It is a therefore another main object of the present invention to provide low power data communication to miniature objects.

Another application of the present invention is in collecting data from remote sensors. Remote sensors are widely utilized in a variety of applications including: chemical sensors located in dangerous locations such as a chemical reaction chamber; air and water pollution sensors where the sensor is floating in the air or on water; temperature sensors such as in ovens, chemical reaction chambers, or nuclear reactors; strain gages such as on the top of a high building other construction such as a bridge; a video camera in a hazardous materials facility; an array of video cameras outside a protected facility such as a prison or a military facility or along a fence; or a camera in a battle field.

Generally such sensors store the information they gather in a memory element and communicate the information to information consumer. All sensors and information storage devices (which are referred to collectively as sensors herein) utilize some form of energy source, which frequently is electrical batteries. In all these cases there is a necessity to utilize energy saving components in order to avoid as much as possible battery replacement, which may be inconvenient or dangerous. In some applications, the number of sensors may be very large, to the extent of making battery replacement impractical. In other cases, change of the battery is so inconvenient that the introduction of the sensor into the market depends on energy saving, namely on very low consumption of energy. An energy-consuming component in all sensors is the transmitter, which transmits the information gathered by the sensor to a remote station, which receives the information. Such a transmitter can be a microwave transmitter, which is often utilized in “Bluetooth” transmitters. It would be advantageous to improve the operational properties of remotely deployed sensors or information storage devices by reducing the energy consumption of the transmitter, which transmits the collected information.

Some sensors such as chemical sensors transmit at low bandwidth, which can be as low as 10 Hz in the case of detection of a single type of molecule in the time interval of a few seconds. Some sensors may store the information for one day and transmit the information at a very low rate such as 1 Hz. Other sensors such as a real time video cameras may transmit information at a rate as high as 10 Mega Hz. As a result, in many sensors, the modulator of the transmitted signal should be capable of modulating signals at a very high repetition rate.

There is also a wide variety of operating ranges of remote sensors. Some chemical sensors, such as a sensor located in a hazardous reaction chamber may be monitored from a distance of a few meters. On the other hand, sensors, which are deployed around a protected facility, may be monitored from a distance of a few tens of meters. Sensors in a battlefield may be monitored from a distance of a few hundred meters or a few kilometers. Sensors located in the sea may also be operated from a few kilometers.

In many cases a sensor may accumulate information for a time duration, and only later release the information to a user. As an example of that specific mode, a commercial consumer digital camera such as utilized by tourists and produced by companies such as Nikon, Fujinon, HP, Kodak and others, accumulates a number of pictures and stores them in a flash memory. The flash memory may be removed and provided to a picture development center for printing. The process of removing the memory and physically providing it to a development facility is time consuming and often requires waiting in line. It would be advantageous if the stored information could be transmitted via wireless communication to the printing center. This would enable camera users to pass by a printing center and instantly transmit the pictures for printing, even through the shop glass window, when the shop is closed. However, transmitting the information is energy consuming and cameras batteries normally don't last long enough.

It is a therefore another main object of the present invention to provide low energy saving communication channel between a camera and an information receiver.

It is another main object of the present invention to provide detection of unauthorized intrusions in a manner that is secure and consumes minimal energy.

In some cases retromodulated communication is not possible due to a lack of line of sight between transceiver and retromodulator. For example in a case of gathering data from remote sensors in a pipeline.

It is a therefore another main object of the present invention to provide a fiber retroreflecting link for conditions where there is no direct line-of-site between the retromodulator and the transceiver.

### BRIEF DESCRIPTION OF THE INVENTION

There is thus provided in accordance with a preferred embodiment of the present invention, a data communication system comprising a transceiver unit for retromodulated optical communication with at least one of a plurality of retromodulator units, the transceiver unit comprising at least one of a plurality of transceivers, the transceivers transmitting diffused radiant energy at different angles covering a predetermined three-dimensional area, wherein each transceiver is enabled to set up and execute communication with at least one retromodulator unit located within its coverage area.

Furthermore, in accordance with another preferred embodiment of the present invention, the coverage areas are contiguous.

Furthermore, in accordance with another preferred embodiment of the present invention, the coverage areas overlap.

Furthermore, in accordance with another preferred embodiment of the present invention, each transceiver is further enabled to maintain continuous communication with a retromodulator unit that moves between coverage areas.

Furthermore, in accordance with another preferred embodiment of the present invention, the invention comprises at least one of a plurality of retromodulator units, where the retromodulator unit comprises multiple arrays of lenslets connected to a common modulator and reflector.

Furthermore, in accordance with another preferred embodiment of the present invention, the retromodulator unit comprises a spherical arrangement of lenslets connected to a common modulator and reflector.

Furthermore, in accordance with another preferred embodiment of the present invention, the retromodulator unit is provided with an interface for communication with a data processing device.

Furthermore, in accordance with another preferred embodiment of the present invention, the invention further comprises at least one of a plurality of retromodulator units, where the retromodulator unit comprises two or more parts, each part comprising a narrow band-pass optical filter and a modulator, each part communicating with a separate segment of the transceiver unit.

Furthermore, in accordance with another preferred embodiment of the present invention, the transceiver unit is configured to transmit low level radiation until detection of a retromodulator unit, whereupon the radiation level is increased in the transceiver covering the predetermined three-dimensional area in which the detected retromodulator unit is located.

Furthermore, in accordance with another preferred embodiment of the present invention, detection of the retromodulator unit is triggered by retroflected radiation from the retromodulator unit received by the transceiver unit.

Furthermore, in accordance with another preferred embodiment of the present invention, detection of the retromodulator unit is triggered by retromodulated radiation from the retromodulator unit received by the transceiver unit.

Furthermore, in accordance with another preferred embodiment of the present invention, the radiant energy is transmitted and received via an optical fiber.

Furthermore, in accordance with another preferred embodiment of the present invention, the radiant energy is modulated at a high frequency.

Furthermore, in accordance with another preferred embodiment of the present invention, the retromodulator unit is integrated into a remote control and communicates control data to the transceiver unit, which is integrated into a device controlled by the remote control.

Furthermore, in accordance with another preferred embodiment of the present invention, the remote control further comprises one or more photovoltaic cells.

Furthermore, in accordance with another preferred embodiment of the present invention, the remote control further comprises a battery charger.

Furthermore, in accordance with another preferred embodiment of the present invention, the retromodulator unit is integrated into an an electronic remote identification card and the transceiver unit is implemented in an access control point.

Furthermore, in accordance with another preferred embodiment of the present invention, the invention further comprises analyzing components for comparing biometric information permanently stored in the card with real-time biometric information obtained from the card owner.

Furthermore, in accordance with another preferred embodiment of the present invention, the real-time biometric information obtained from the card owner is sent to the transceiver unit via the retromodulator.

Furthermore, in accordance with another preferred embodiment of the present invention, the retromodulator unit is integrated into a micro aerial vehicle and the transceiver unit is a data collection station.

Furthermore, in accordance with another preferred embodiment of the present invention, the transceiver unit is integrated into a micro aerial vehicle and the retromodulator unit is a remote sensor.

Furthermore, in accordance with another preferred embodiment of the present invention, the transceiver unit is integrated into a data collection station and the retromodulator unit is a remote sensor.

Furthermore, in accordance with another preferred embodiment of the present invention, the remote sensors are installed internally along the length of a pipe.

Furthermore, in accordance with another preferred embodiment of the present invention, the transceiver unit is integrated into a data collection station and the retromodulator unit is a remote sensor that detects intruders.

Furthermore, in accordance with another preferred embodiment of the present invention, the transceiver unit is integrated into a photographic printing service and the retromodulator unit is integrated into a camera.

Furthermore, in accordance with another preferred embodiment of the present invention, the transceiver unit is integrated into a personal computer and the retromodulator unit is integrated into a camera.

Furthermore, in accordance with another preferred embodiment of the present invention, the transceiver unit is integrated into a media system and the retromodulator unit is integrated into remote identification tag.

### BRIEF DESCRIPTION OF THE FIGURES

The invention is described herein, by way of example only, with reference to the accompanying Figures, in which like components are designated by like reference numerals.

FIG. 1A illustrates a base system for retromodulated data communication in accordance with a preferred embodiment of the present invention.

FIG. 1B illustrates a data producer is transmitting data to a transceiver unit in accordance with a preferred embodiment of the present invention.

FIG. 1C illustrates another data producer is transmitting data to a transceiver unit in accordance with a preferred embodiment of the present invention.

FIG. 2A illustrates an exemplary retromodulator unit.

FIG. 2B illustrates an exemplary lenslet array of “cat's eye” lenses.

FIG. 2C illustrates a retromodulator unit comprising an arrangement of three lenslet arrays in accordance with a preferred embodiment of the present invention.

FIG. 2D illustrates a retromodulator unit comprising an arrangement of six lenslet arrays in accordance with a preferred embodiment of the present invention.

FIG. 2E illustrates a retromodulator unit comprising a hemispherical arrangement of lenslets in accordance with a preferred embodiment of the present invention.

FIG. 2F illustrates an alternative embodiment of retromodulator unit where bandwidth is doubled by dividing the retromodulator unit into two parts with different narrow band-pass optical filters and different modulators.

FIG. 3A illustrates an exemplary transceiver for a retromodulated communication system.

FIG. 3B illustrates an exemplary transceiver for a retromodulated communication system transmitting and receiving via optical fiber.

FIG. 3C illustrates another exemplary transceiver for a retromodulated communication system.

FIG. 4 illustrates a remote network connection application for a retromodulated communication system in accordance with a preferred embodiment of the present invention.

FIG. 5 illustrates a remote device control application for a retromodulated communication system in accordance with a preferred embodiment of the present invention.

FIG. 6 illustrates a smart identification application for a retromodulated communication system in accordance with a preferred embodiment of the present invention.

FIG. 7 illustrates a remote sensor data collection application for a retromodulated communication system in accordance with a preferred embodiment of the present invention.

FIG. 8 illustrates an optical-fiber-based remote sensor data collection application for a retromodulated communication system in accordance with a preferred embodiment of the present invention.

### DETAILED DESCRIPTION OF THE INVENTION

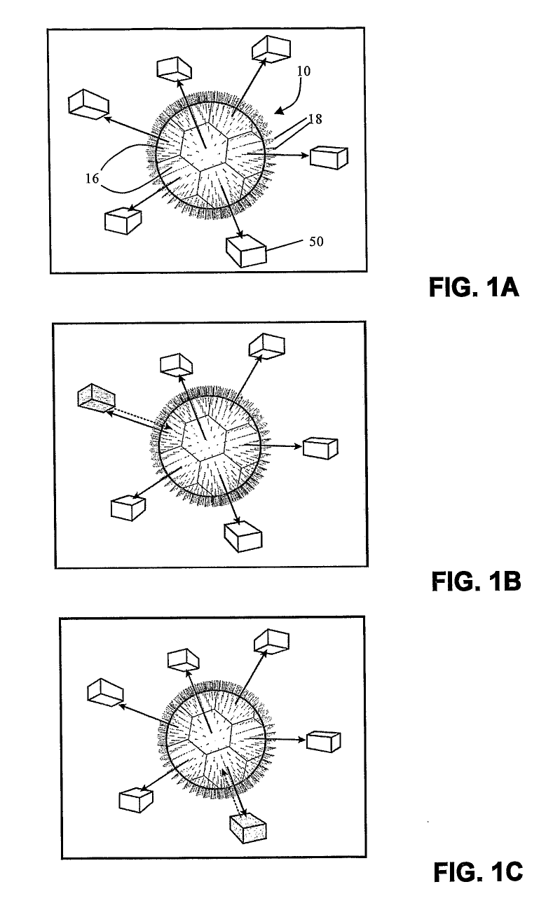

With reference to FIG. 1A, the base system of the present invention is now described.

The base system comprises two primary units: transceiver unit 10 and retromodulator unit 50. Retromodulator unit 50 is capable of modulating a beam of radiant energy received from transceiver unit 10 with data and retroreflecting the modulated beam back to transceiver unit 10 where the data is demodulated from the beam, thereby resulting in data communication from the retromodulator unit 50 to the transceiver unit 10. Various novel applications are made possible by incorporating transceiver unit 10 into a device referred to herein as a data consumer and retromodulator unit 50 into a device referred to herein as a data producer.

A data consumer represents a device that uses a transceiver unit 10 to retrieve data from a retromodulator unit 50 on a data producer device.

Transceiver unit 10 comprises at least one of a plurality of segments. Each segment comprises a transceiver capable of transmitting a diffused radiant energy beam 18 (preferably infrared wavelength) at a different angle and receiving back retroreflected energy from that same angle. Each segment thus covers a predetermined three-dimensional area, with multiple contiguous segments providing wide angle coverage of a large area. Thus a spherical transceiver unit in accordance with a preferred embodiment of the present invention comprises contiguous segments making up a sphere and covering the entire three-dimensional area around it with transmission and reception. Similarly, a hemispherical transceiver unit covers half the three-dimensional area around it, and so forth. Preferably segments 16 are contiguous and configured such that their areas of coverage overlap enough that there is no interruption of communication when a retromodulator moves from one sector's area of coverage to another's.

FIG. 1B and FIG. 1C illustrate cases where a different data producer is transmitting data to the transceiver unit. In each case, only the beam in the segment covering the area containing the communicating retromodulator (data producer) is at high enough power level for the data producer to send data by modulating the beam. While the figures illustrate cases of a single data producer communicating with the transceiver unit, it is also possible for multiple data producers to simultaneously communicate with the transceiver unit, each data producer communicating with a different segments on the transceiver unit.

In a preferred embodiment of the present invention, when a segment is not receiving data from a data producer, the segment broadcasts at a low level, thereby saving energy and reducing the effect of the radiant energy on its environment.

When a retromodulator unit 50 comes within a segment's area of coverage, retromodulator unit 50 retroreflects energy beam 18 back to the segment. Depending on how the system is configured, the segment can ignore the retroreflected energy or react to it. It depends on who is to initiate the data communication: the data producer or the data consumer.

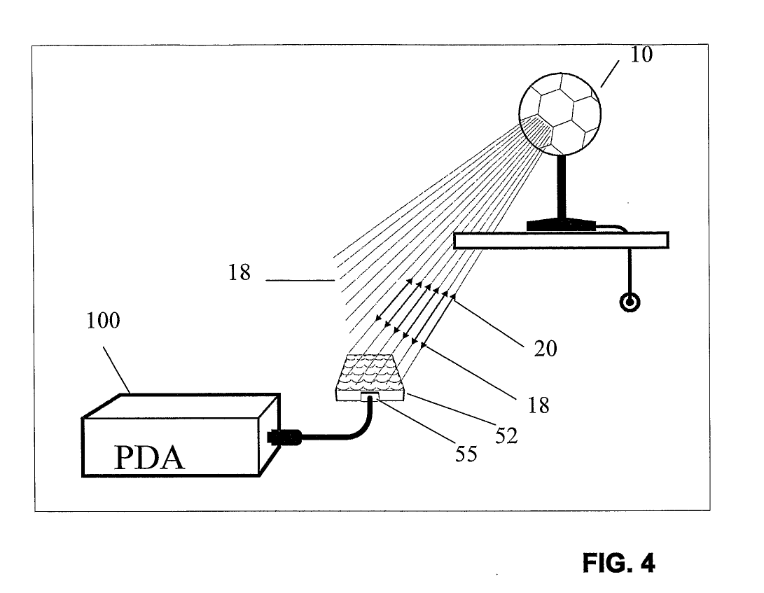

The system will be configured to ignore the retroreflected energy in the case where it is the data producer who initiates data communication. For example, an application described later in this disclosure and shown in FIG. 4 provides a portable computing device provided with a retromodulator for communicating data to a network via a transceiver. Such an application is suited for public spaces such as an airline terminal. In such a space at a given time there may be many PDAs and it should be up to the PDA owner to decide whether and when to connect to the LAN.

Therefore, in such a case where the data consumer initiates data transfer, a segment does react to retroflected energy. Instead, it waits until the data consumer (PDA in this example) signals its intention to transmit data by unilaterally modulating the retroreflected beam. The segment detects the modulation activity and increases the power of beam 18 so that the beam is high enough for the PDA to modulate it with data.

Alternatively, the system will be configured for the segment to react to retroreflected energy in the case where it is the data consumer who initiates data communication. For example, an application is described later in this disclosure where a MAV comprises a transceiver unit 10 that receives data from one or more remote sensors, each comprising a retromodulator. In that case, it is preferable for the data consumer (the MAV) to initiate data communication. Therefore, upon detection of a retromodulator unit 50, the transmitting segment 16 unilaterally increases the level of radiated energy beam, thereby signaling the data producer to start modulating the beam to transfer data.

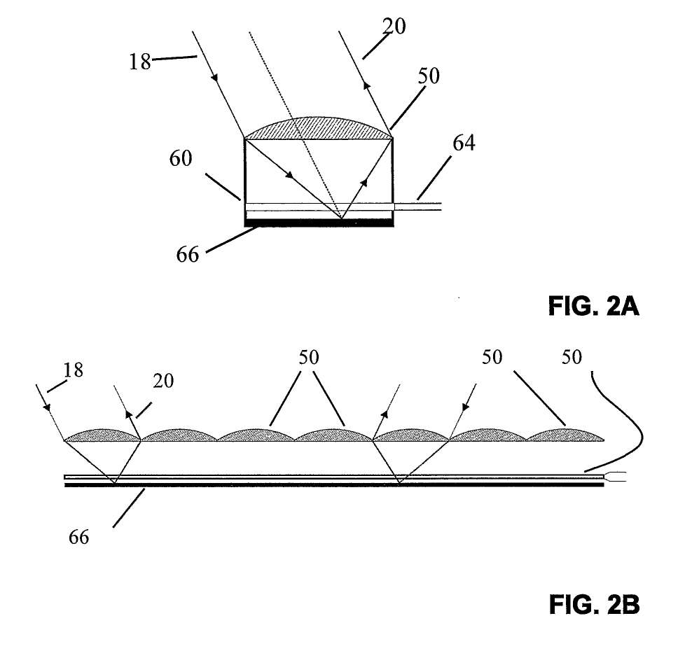

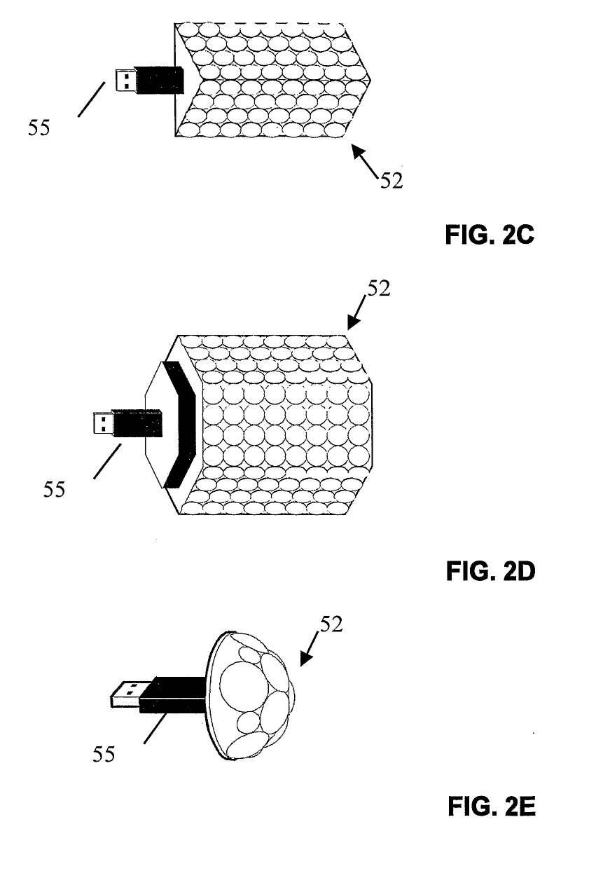

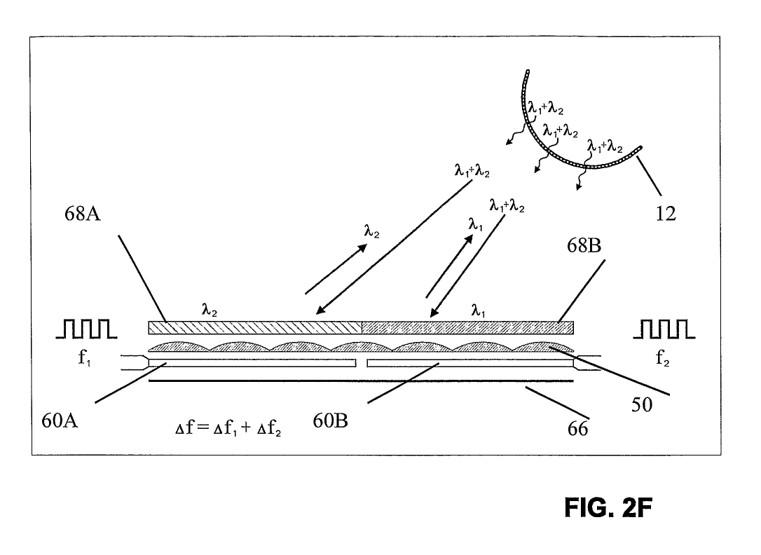

Retromodulator construction is well known to those skilled in the art. FIG. 2A depicts a typical basic retromodulator unit 50 configuration. Lens 56 receives incident radiation beam 18 from transceiver unit 10. Modulator 60 is fed a modulating signal 64 by a parent data collection device and modulates beam 18 accordingly. The modulated beam 20 is retroreflected by mirror 66 back to transceiver unit 10.

An exemplary modulator 60 in the visible and IR range may comprise a fast liquid crystal shutter such as a PDLC (polymer dispersed liquid crystal).

Another exemplary modulator 60 is a liquid crystal plate, such as produced by 3M Corporation.

Another exemplary modulator 60 is a micro-electromechanical system (MEMS) mechanical modulator, such as that described in US patent application PCT/1L01/00945.

Exemplary modulators for mm and terahertz wave modulation include:
Using a piezoactuator and a corner cube to alter the perpendicularity of the facets.
Using a polyethylene lens (at 650 GHz) and an alternating grid and focal zone.

Other exemplary alternatives of modulator 60 comprise a capacitive microphone or a piezoelectric transducer.

There is also a group of nano-technology-based modulators suitable for the present invention. Several-existing approaches to light modulation, based on nano technology, are feasible (Workshop on Nanoscience for the Soldier, ARO 2001, www.aro.army.mil/phys/Nanoscience/sec4nano.htm):
1. Nano-structured surfaces for alignment of LCD (Liquid Crystal Displays).
2. Encapsulated liquid crystals.
3. Direct scan using nano-electro-mechanical devices (NEMS) for steering.
4. Enhanced emission with structured surfaces (100x).
5. Charged nanotubes arrays in vacuum for low voltage operation.
6. Quantum well/wire/dot emitters, or atomic clusters
7. LCD nanomolecules
8. Photonic bandgap (PBG) materials for reflective image from visor

Furthermore, colloidal semiconductor nanocrystals (NCs) is one of the groups that can be considered for modulation, due to their quanatized electronic states. In other words, these NCs may act as an optical modulator. Saturation may be obtained by optical pumping, or by injection of carriers from the outside world. In the said modulator the normal state is opaque absorbing the light in the required wavelength, upon excitation, either optical or electrical the modulator changes to transparent.

The embedding of the active nano component in an optical fiber is also possible. This fiber can then be used as an optical modulator using either of the two approached described above.

Preferably, retromodulator unit 50 comprises a reflecting layer 66. Alternatively retromodulator unit 50 comprises a liquid crystal unit.

An exemplary reflecting layer 66 comprises stripes of reflecting material interspersed with non-reflecting material. Preferably, the reflecting layer is superimposed on a second layer comprising stripes of non-reflecting material interspersed with transparent material.

Preferably, the reflecting layer is a substrate (glass or polymer) doped with nanoparticles that can change the optical properties.

One embodiment of the retromodulator uses Colloidal semiconductor nano crystals (NCs), which can be considered as “artificial atoms”, The NCs of the IV-VI compounds (PbS, PbSe) are of particular interest due to their optical activity in the IR spectra regime. An injection of carriers into these “artificial atoms” brings them into saturable state. Thus, the NCs become transparent to the light under saturation conditions and absorbing at non-saturated conditions. Thus these NCs may act as an optical modulator.

It can be shown that a basic PIN based PMRF communication channel will operate with a S/N ratio of 200 from a distance of 10 meters, or S/N ˜20 from a distance of ˜30 meters. That inexpensive option is attractive for low-end sites such as cafe or private houses.

The utilization of avalanche photodiodes in high end sites will increase the S/N ratio by few orders of magnitude, allowing operation from a distance of over 30 meters with larger bandwidths.

Battery energy saving analysis:

It can be shown that a 30 meter, 100 kbits/sec PMRF based wireless communication channel is feasible with battery power consumption as low as 0.6 milliwatts !!. That consumption level is 50 times lower than available with microwave based Bluetooth.

A thin retromodulator unit 50 can be used in combination with a lenslet array of “cat's eye” lenses, such as is manufactured by Fresnel Optics Corp (FIG. 2B).

If the field of view of retromodulator unit 50 is too narrow then incident beam 18 will be only partially reflected to transceiver 12. To overcome this limitation, several lenslet arrays can be used and/or lenslets can be arranged in a curved arrangement, such as a hemispherical or spherical arrangement. FIG. 2C illustrates a retromodulator unit comprising an arrangement of three lenslet arrays. FIG. 2D illustrates an arrangement of six lenslet arrays. FIG. 2E illustrates a hemispherical arrangement of lenslets. The retromodulator units of FIGS. 2C, 2D, and 2E are further provided with with an interface 55 (such as a universal serial bus (USB) connector) for communication with a data processing device.

FIG. 2F illustrates an alternative embodiment of retromodulator unit 50 where bandwidth is doubled by dividing the retromodulator unit into two parts, each part comprising a narrow band-pass optical filter 68A and 68B of different wavelength and modulated by a different modulator 60A and 60B with different data at a different bandwidth. Each part retromodulates different incident beams 18, which are transmitted at different wavelengths by two different transceivers 12 in transceiver unit 10. The result is a doubling of the effective bandwidth of the retrormodulated information.

There is a tradeoff between bandwidth and operating range. Doubling the bandwidth in this manner reduces the reflecting area of each channel (assuming that the total size is maintained unchanged) by a factor X2, reducing the receiver power by a factor X2, and resulting in a reduction of range by a factor 2ˆ½.

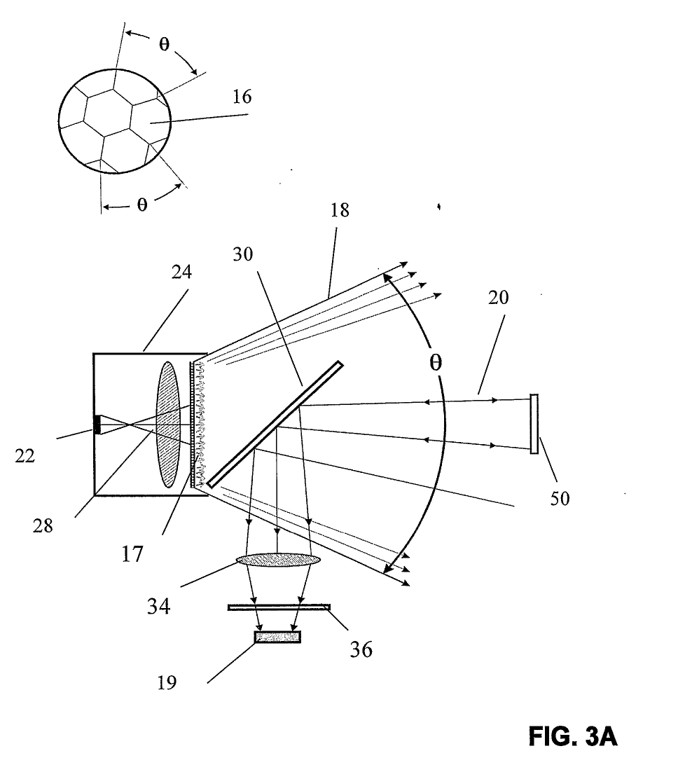

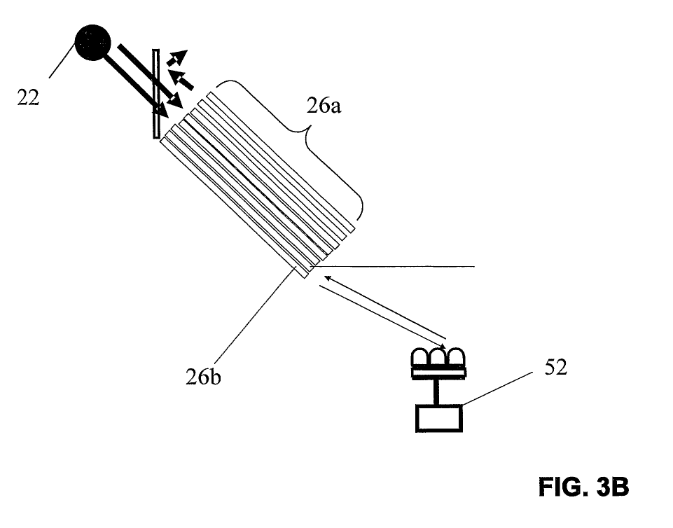

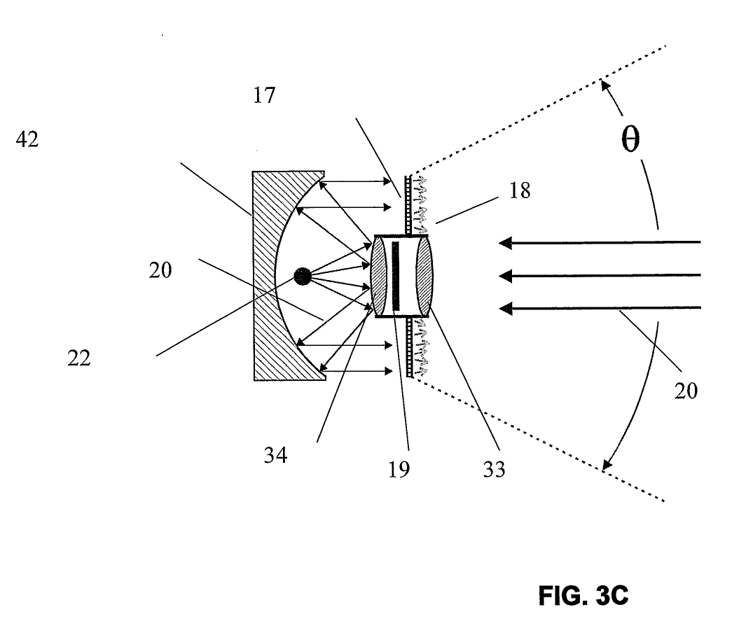

An exemplary transceiver 12 is shown in FIG. 3A. Transceiver 12 is enclosed in transceiver enclosure 24. Beam source 22 could be a diode, a diode stack, a lamp, or similar source that transmits a radiant energy beam 18. Beam 18 passes through lens 18 and diffuser 17, which makes the beam eye-safe and compliant with safety standards, such as ANSI Z 136.1. Beam 18 is emitted at angle Theta. If beam 18 encounters a retromodulator unit 50, the beam is modulated with data from the retromodulator unit's host data producer and retroreflected back 20 by retromodulator unit 50 to transceiver unit 10 where it is demodulated and the data passed to the transceiver unit's host data consumer.

Beam source 22 typically emits monochromatic light at any wavelength between 750 nm and 1500 nm. Other wavelengths may be utilized as well. The selection of wavelength is the result of a tradeoff between eye safety (1500 nm is safest), cost of transceiver power source, and transceiver detector 19 sensitivity and noise level. The level of background radiation from ambient light sources is another source of noise to detector 19 and may also affect the selection of the operating wavelength. Lens 56 F-number may be 1.5. This assures a wide viewing angle close to 60 degrees.

The utilization of electromagnetic waves with wavelengths ranging between the infrared range and the microwave range (millimeter to terahertz frequency range) is well known in the prior art. Thus radiation in the visible, IR, mm and tera Hz could be used in the present invention. The advantage of the longer wavelength is in the ability to overcome the line of sight restriction of visible or IR radiation.

Furthermore ultrasonic radiation can also be retromodulated, facilitating a non-electromagnetic communication link that provides operation of the present invention at long distances undersea.

Beam source 22 may be cooled if necessary. An exemplary beam source 22 is a 1 watt infrared diode manufactured by Agilent USA. Other exemplary beam sources are a halogen lamp with a narrow band filter or a Krypton gas discharge lamp, which emits a few peaks in the infrared and is manufactured by ILC or Hereaus of Germany.

Operation of beam source 22 for a duration T (seconds) generates maximum permitted radiance M as given by M=10 k1*k2 Joules/cm2 steradians, where k1=1, k2 depends on wavelength and is ˜1.5 at 980 nm. Assuming communication duration of 10 seconds followed by an intermission leads to a power density level of 1 watts/cm2/strad. Assuming 10 degrees diffuser (˜⅙ radian, PI/100 steradian) and a 2 cm diameter segment (4 cm2 area), we obtain a power level of ˜150 milliwatt. A typical power level emitted through a single segment is 0.15 watts, and the diameter of a segment 70 is 1 to 3 cm. An array of 200 segments will radiate ˜30 watt. Transceiver 12 will act as an infrared eye-safe lamp of 30 watts power level with a surface area of ˜300 cm2.

Emitted beam 28 is diffused by diffuser 17 and transmitted as diffused beam 18 to the surrounding space. Beam splitter 30 is located in front of diffuser 17 and may also serve as a filter 32 to allow only the monochromatic radiation of the transceiver. The modulated beam 20 returned by retromodulator unit 50 is bounced by beam splitter 30 through receiver lens 34 and receiver narrow band pass filter (thus improving signal to noise ratio) 36 to detector 19.

Band pass filter 36 rejects ambient radiation at any wavelength outside the emission spectrum of beam source 22, thereby reducing ambient shot noise in detector 19. A typical receiver narrow band pass filter 36 will have a 20 nm bandwidth with a central bandwidth between 750 nm and 1500 nm. Such filters are available from Edmund, USA. Detector 82 can be a photodiode such as a Si photodiode, a Si avalanche photodiode, or other semiconductor photodiode, preferably sensitive to wavelengths up to 1500 nm. A photo multiplier, such as by Hamamatsu, is also a suitable detector 82.

The diameter of detector 19 should be large enough to receive radiation reflected from a retromodulator located in an area covered by a given segment 16.

The larger the diameter of detector 19, the wider the detection field of view. On the other hand, the larger the detector, the higher the shot noise generated by the detector and the lower the signal to noise ratio and the quality of the communication channel. By minimizing the F-number of receiver lens 34, it is possible to reduce detector diameters. A typical lens diameter 80 is ˜1 cm, and the F-number ˜1. The typical diameter of the detector for a field of view 10 degrees (˜⅙ of a radian) is ˜1.5 mm. A 1.5 mm detector may generate a lower than 10 nano Amper dark current.

The output signal 38 from detector 19 carries the information generated by the data producer and is fed to the data consumer.

FIG. 3B illustrates an alternative transceiver unit 10 comprising a high power beam source 22 feeding light guide 26A, which comprises many smaller optical fibers 26B, each serving as the channel for the transmit beam 18 and retromodulated beam 20 pair of a particular segment.

FIG. 3C illustrates an alternative embodiment of transceiver 12: a concentric “Cassagrain” type transceiver. In this configuration, beam source 22 is located in front of convex mirror 42. The beam emitted by beam source 22 is reflected by concave mirror 34 to convex mirror 42 and reflected again toward diffuser 17. As a result an eye-safe diffused beam 18 is created with a diverging angle THETA. The retromodulated return beam 20 is collected by lens 33 into detector 19 where it is demodulated and then transferred to the host data consumer.

As was previously mentioned, according to a preferred embodiment of the present invention, transceiver unit 10 initially broadcasts with minimal energy radiation from transceiver 12, thereby improving eye safety and energy consumption. Transceiver segments 16 radiate diffused beams 18 at very low power levels, for example just 10 milliwatt. When a retromodulator unit 50 is present at a location within range of transceiver 12, the segment 16 transmitting to that location will detect the modulated beam 20 returned by the retromodulator 52.

There are two alternative methods for how the retromodulator works.

Method 1: Retromodulator is passive—it just retroreflects the incoming beam. The beam is detected at the transceiver and the transmission energy is increased. The increased energy prompts the retromodulator to start modulating and transmitting information.

Method 2: The retromodulator is active and retromodulates the incoming beam. When the transceiver detects the retromodulated beam, the transmission energy is increased and the communication link is activated.

Method 1 is suitable for remote stations accumulating information and prompted by the transceiver when to transmit.

Method 2: is more suitable for portable devices, PDAs, cell phones etc. where initiation of the communication comes from the PDA user.

In another embodiment of the invention, the beam source 22 for each segment is modulated at a high frequency, such as 1 MHz. The high frequency enables detector 19 to avoid ambient low frequency optical noises, such as those originating in fluorescent lamps.

In another embodiment of the invention, it is retromodulator unit 50 that modulates the reflected beam 20 at a constant frequency, thereby also avoiding ambient light interference.

In an alternative preferred embodiment of the present invention (FIG. 4), a network connection is established by communicatively connecting a retromodulator unit 50 to a personal digital assistant (PDA) 100 (or other portable data processing device, such as cell phone or laptop computer). The communication connection is preferably via a port on PDA 100, such as a universal serial bus (USB) port using a connector 55 (FIG. 2C, FIG. 2D, FIG. 2E) that can be integrated into retromodulator unit 50 or attached to it by cable.

Transceiver unit 10 is located in line of site of retromodulator-equipped PDA 100. Preferably transceiver unit 10 is mounted, for example on a wall or the ceiling of a structure 102, such as a room or hall. Examples of structures 102 include an airport terminal, an office, or restaurant.

An exemplary transceiver unit 10 could be a 10 cm sphere transceiver 12 comprising 300 segments 16, each segment spanning a solid angle 4PI/300 ˜ 1/25 steradian ˜12 degrees. The resulting pattern of radiation beam 18 in the vicinity of the PDA will have a diameter of 3 meter/6=50 cm if the PDA is located at a distance of 3 meters from the transceiver.

Preferably the aggregate area covered by combined segments is the entire space (floor) of structure 102. A PDA 100 operated by a user located at a given point in structure 102 will receive radiation from the particular segment 16 of transceiver 12 that covers the area comprising that point.

Retromodulator unit 50 receives a data signal from PDA 100 or other portable device (e-mail, file transfer, etc.), uses the signal to modulate the beam 18 received from a segment 16, and reflects modulated beam 20 back to the originating transceiver segment 16. Transceiver 12 demodulates the signal and transmits it via a standard communication channel 104, such as a WiFi microwave or diffused infrared to network connection 106, which connects to a LAN, the Internet, or other network.

An alternative embodiment of the present invention accommodates a need to support the data communication in a structure 102 that is larger than the capacity of a single transceiver unit 10—for example an airport terminal. In that case multiple transceiver units 10 are dispersed across the structure such that each point in the terminal is covered by at least one segment of one transceiver 52.

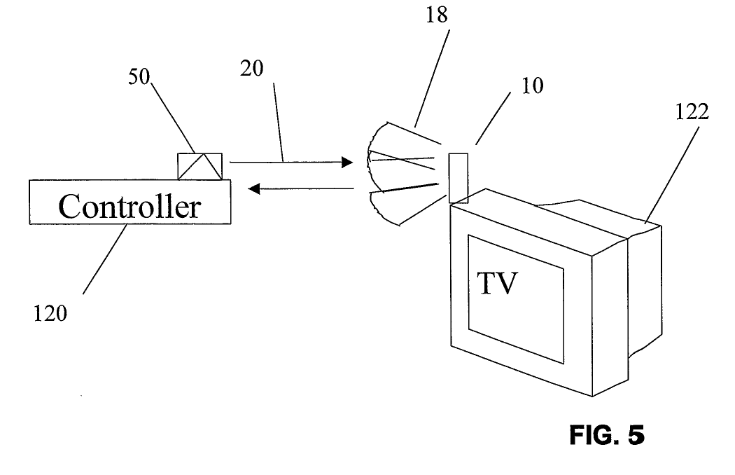

Another preferred embodiment of the present invention (FIG. 5) implements data producer as a power-saving remote control 120 and data consumer integrated in or with one or more devices 122 controlled by the remote control, for example a television, a game, a computer, an entertainment center, an appliance, or other device in a smart home, factory, or office.

Transceiver unit 10 is located in the room, usually on or inside the controlled device 122. Retromodulator unit 50 is incorporated into controller 120 and modulates light 124 emitted by the transceiver unit 50. As in the previous described embodiment, transceiver unit 50 emits very low level radiation 18 until transceiver unit 50 detects retromodulated beam 20, which indicates the intention to use the controller. The information sent by the user of the controller modulates the retromodulated beam 20. As a result, controller energy is expended only on modulation. The bandwidth utilized in a retromodulator controller is usually very small, perhaps as low as 10 bits/sec.

In an alternative embodiment one or more photovoltaic cells and a battery charger are included in controller 120 such that controller 120 does not need a battery at all.

In a related alternative embodiment, the IR radiation 18 of the transceiver illuminates the photovoltaic cells to generate the required electric energy for the remote controller.

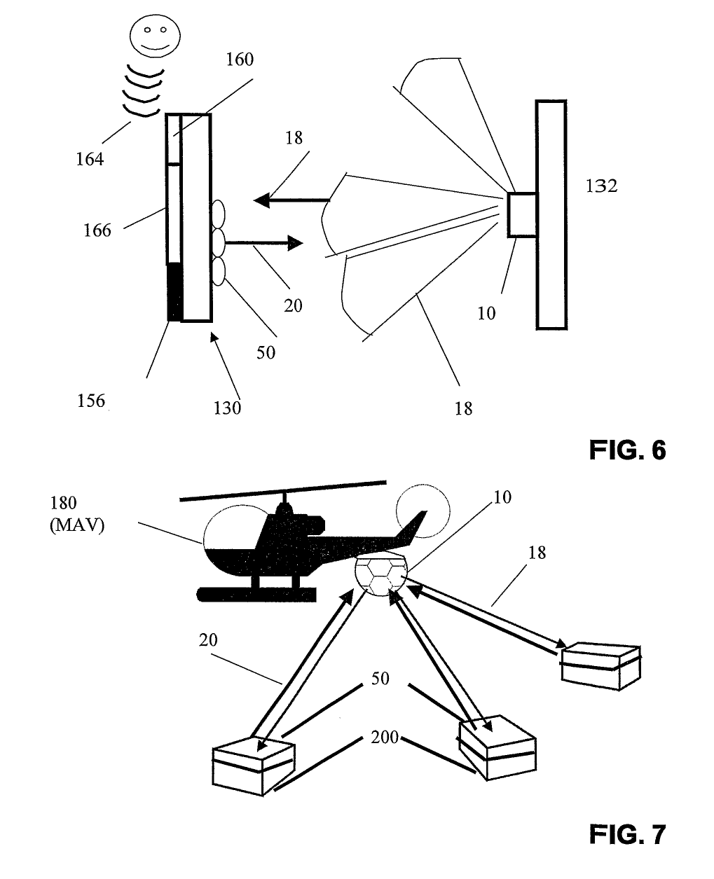

Another preferred embodiment of the present invention (FIG. 6) implements data producer as a smart card 130 and data consumer as a secure control point 132. IR beam 18 reaching the card is modulated by retromodulator unit 50 according to commands set by processor 156, which is also embedded in the card.

Transceiver 12 transmits IR radiation 18 to retromodulator unit 50 on smart card 130. Retromodulator unit 50 modulates the radiation with biometric information stored on card 130 and/or with biometric data acquired by the card from card holder 164. Retromodulator unit 50 retroreflects the modulated radiation back to transceiver unit 10 which demodulates the information for a data consumer in the form of a security person or security system 167.

Optionally, card 130 can include one or more sensors 160 to detect actual biometric features, such as: voice; face morphometric features; fingerprints, etc. The system configuration changes accordingly.

Voice Feature: Card holder 164 speaks into microphone (voice sensor) 160. The voice is processed in processor 156 to extract characterizing voice features and the data compared with voice data stored in memory 166 and/or transmitted via retromodulator 50 unit to control point 132.

In one embodiment of the invention, smart card 130 incorporates a microphone 160. When required, the card owner speaks and emits sound waves. The real time voice signal is digitized and temporarily stored in memory 166. A comparison password voice signal is permanently stored in memory 166. Both signals are fed to retromodulator 52 and the results sent to control point 132.

Access control point 132 incorporates transceiver unit 10, which emits a beam and detects the retromodulated input from retromodulator unit 50. The input includes both the stored voice password input and the real time voice signal input. Access control point 132 incorporates a processor for comparing the two inputs.

Therefore the card holder can talk into the card and transmit a voice response to a guard query. The card is thereby transformed into a sort of lie detector or a tool for voice stress analysis with a stored baseline.

Morphometric feature: Smart card 130 comprises video camera (visual sensor) 160 to acquire an image of the card holder. The image is digitized in a frame grabber and the extracted shape data is compared to the permanent data stored in the card and sent to processor 156 for comparison.

Fingerprint identification feature: smart card 130 comprises a fingerprint analysis unit (fingerprint sensor) 160. Card holder 164 puts his fingers into the unit for analysis, which is sent to sent to processor 156 for comparison.

Other embodiments of biometric remote identification can be in other portable miniature devices such as a wristwatch; a pen; a PDA or a cellular phone.

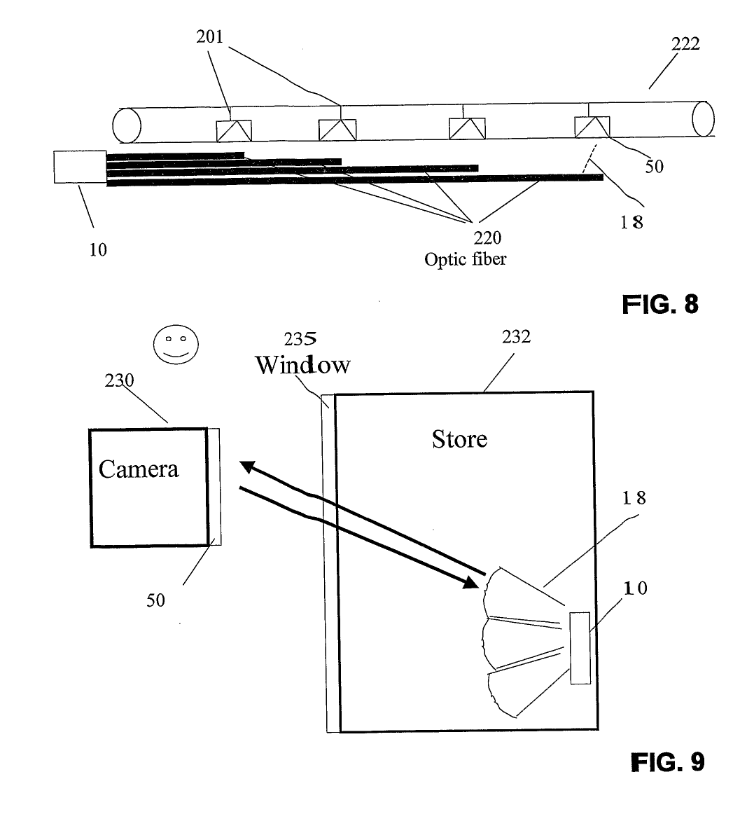

Another preferred embodiment of the present invention (FIG. 7) implements the data consumer as a a MAV (micro aerial vehicle), such as a mini-helicopter, and data producer as a remote sensor 200 deployed in remote location, which might be an agriculture field, a city street, a residence, an office, a fence, a battlefield, or the surface of the sea.

Remote sensor 200 comprises a sensing element that gathers data and uses it to modulate retromodulator unit 50 resulting in the modulation of return beam 20. The modulation can be done in real time or, if remote sensor 200 is provided with memory, the data can be stored and the modulation done at a selected time.

The physical features sensed by sensing element 200 may be of many types, for example ground moisture, concentration a poisonous chemical agent, ground pollution level, water pollution level, strain on a structural reinforcing element, temperature in an oven, or an image stored in a security camera or a traffic speed detection camera. Such remote sensors are well known in the state of the art by any skilled engineer.

In an alternative embodiment of the present invention, the transceiver unit 10, is located on a miniature airborne vehicle (MAV) such as an unmanned airplane. An exemplary transceiver 12 for such an application comprises an array of Cassagraine transceivers where each transceiver continuously emits low-level radiation till it detects a retromodulator unit 50 on a remote sensor 200. The continuous emission of low-level radiation eliminates the necessity for utilizing a scanner, which might also consume too much energy. The operating bandwidth for the process of locating retromodulator unit 50 is low since no information is to be detected, excluding some basic modulation, which helps to differentiate retromodulator unit 50 from the background.

Once transceiver unit 10 detects retroreflected light from a retromodulator unit 50, a signal is generated to increase the transmitted radiation level. The angular divergence of the emitted beam, Theta, should enable coverage of a large enough area in the vicinity of retromodulator unit 50 to ensure sufficient communication time during the propagation of the MAV, which travels at a velocity V.

An exemplary system of the type could be based on a typical MAV velocity of 60 Km/hour (˜15 m/sec) at a typical operating height of 200 m. In order to establish a communication channel for a duration of ˜2 second, the emitted beam divergence Theta should be ˜ 2/10 radians (˜12 degrees).

Two-approaches to handshaking are possible: In one approach, the retromodulator is passive, just retroreflecting the incoming beam, the beam is detected at the transceiver and the transmission energy is increased. Then the increased energy prompts the retromodulator to start modulating and transmitting energy.

The second approach is that the retromodulator is active and retromodulates the incoming beam. When the transceiver detects said retromodulated beam the transmission energy is increased and the communication link is activated.

In an exemplary system, a low-weight (less than 1 Kg) transceiver of 50 mm receiving optics and 100 mm emitting optics is built and installed on the MAV. A 1-Watt diode laser operating at 900 nm is incorporated in the transceiver. Retromodulator unit 50 diameter is also 50 mm. The reflected divergence is 5 milliradians, which is over X10 times the diffraction limited divergence. Remote sensors 200 in this example detect a chemical agent. The information bandwidth is lower than 1000 Hz (based on the necessity to measure spectral properties of various agents in the duration of 1 second). The transceiver detector 19 (in the MAV) is a PIN Si photodiode with a current response of 0.5 A/Watts and a dark current of 2 nanoamp. A load resistor 208 of 100 ohms is used. Based on these specifications, the signal to noise ratio in transceiver detector 19 can be calculated according to the equations:
P(received)=P(transmitted)*(dretroˆ2)*(drec ˆ2)/(Theta ˆ2*Theta(retro)ˆ2*Dˆ4) (1)
NEP=(2*id*q+4*k*T/R)ˆ½*Bˆ½*1/r (2)
S/N=P(received)/NEP (3)
where (d retro) and (d rec) are the retromodulator unit 50 and transceiver 12 diameters respectively, NEP is the noise equivalent power of transceiver detector 19, R is the detector load resistor 208 and r is the optical transmission.

Applying the S/N equation yields S/N˜15.

We have assumed a 5-milliradian divergence of the retromodulator optical aperture. We have also assumed an overall optical transmission of 10%. A signal to noise ratio of 15 enables communication with a very low bit error rate. It must be emphasized that the operating range of an MAV system may be much longer, and that also smaller MAV may be utilized. The range of applications is wide. A small MAV may utilize a 5 watts source and still operate with a reasonable S/N.

An exemplary MAV system is a miniature helicopter. The advantage of using a miniature helicopter is the low velocity, which enables the increase of the divergence angle Theta. The helicopter may stay a long time on a single site, thereby avoiding the necessity to switch transceivers or to utilize a tracker, which will stabilize a transceiver on a retromodulator and compensate for the MAV velocity. A low velocity MAV may also be implemented as floating element, such as a lightweight balloon filled with Helium or completely evacuated. While MAV applications have been described here, similar embodiments could operate using a remote balloon, an airplane, a remote pole, or an UUV (unattended underwater vehicle).

In an alternative embodiment , the MAV is used inside a structure. In this case, the MAV can interface to a set of transceivers 52 spread around the structure.

Another preferred embodiment of the present invention implements the data consumer as a data collection station and data producer as a MAV (reverse of its role in the previous embodiment).

The retromodulator unit mounted on the MAV has a wide angle, typically 2Π, to assure an effective link regardless of the position of the MAV The transmitted beam from the data collection station tracks the MAV azimuth and elevation angles using radar, GPS or other means for tracking. The transmitted beam is modulated and retroreflected by a retromodulator unit on the MAV to carry information from the MAV, such as reconnaissance and MAV operating statistics

In an alternative remote sensing embodiment of the present invention (FIG. 8), at least one of a plurality of optical fibers is used as a channel for transmitted beam 18 and modulated returned beam 20. Retroreflected and modulated returned beam 20 impinges on the exit side of fiber channel 220 and propagates back to transceiver 12 with high efficacy since incoming and outgoing angles are retained both during retroreflection and during internal reflection in the fiber.

There are many applications for fiber-based retromodulated remote sensor data collection including:

A) bringing the transceiver beam into a hazardous environment where the concentration level of chemical products in the air or in a liquid, or other parameters, have to be monitored.

B) Communication with a sensor that is under the water.

C) “Last mile” retrieval of information where conventional communication between two locations is not possible (such as between two buildings) and where one side should be energy saving.

D) Sensing of leaks in sewage systems (FIG. 8). The development of cracks in major sewage pipes 222 poses a severe threat to the environment. Once the pipe is leaking, large amounts of waste materials may spill to the sea or proliferate to underground water reservoirs, resulting in long term pollution. The energy saving solution is the installation of crack sensors 201 along the inner surface of sewage pipes 222, with each sensor connected to a retromodulator unit 50. A fiber channel 220 runs the pipe and transmits light modulated with pipe condition data from sensor 200 via retromodulator unit 50 to transceiver unit 10.

The fibers, together with the retromodulation according to the present invention, offer a low power, non-line-of-site solution for retrieving remote sensor information. This is applicable to industrial monitoring in processes, which require intrinsically safe conditions. The whole link is low power, low current and with no galvanic connection. Furthermore another aspect of the present invention is the ability to supply all the necessary energy for the remote sensor via the fiber. A possible embodiment would be for the fiber to carry two wavelengths: one for charging remote sensor 200 and retromodulator unit 50 via a miniature photovoltaic cell and the other wavelength for carrying incident beam 18 to retromodulator unit 50 and for returning retromodulated beam 20 with the sensor data, thereby requiring zero energy consumption of remote sensor 200.

In another preferred embodiment of the present invention, transceiver unit 10 can include a wide-angle receiver for detecting multiple intruders. System power requirements can be kept low by configuring it to emit low continuous power for detecting of the presence of retromodulator unit 50 followed by increased power after retromodulator unit 50 has been detected in order to identify whether the intruder is a friend or a foe. Preferably transceiver unit 10 comprises a multitude of Cassagrain transceivers that combine to emit a wide-angle beam.

Furthermore, retromodulator 52's optical spectrum may be hopped from one wavelength to another in fractions of a second by coating the back mirror of the retromodulator with a spectrally narrowband material such as nano particles of specific size. Such particles produce specific reflective colors. It is also possible to electrically vary the wavelength of the reflecting coating, thereby changing the operating wavelength of the retromodulator. This additional feature makes retromodulator unit 50 tamper-free as time varying color—coding will secure that only the right pattern of colors will be retroreflected.

Another preferred embodiment of the present invention (FIG. 9) implements the data producer as a digital camera 230 and the data consumer as a photograph printing service 232.

Retromodulator unit 50 is integrated into camera 230, thereby enabling wireless the transmission of photographs with minimal or no depletion of camera batteries. Camera 230 could be any commercial digital camera such as produced by companies like Nikon, Fujinon, Pentax, HP, Kodak etc. Current cameras 230 store digital photographs on a flash memory card.

In this embodiment of the current invention, photographs stored in camera 230 memory are fed to retromodulator unit 50. Transceiver unit 10 mounted in photograph printing service 232 premises emits a wide-angle beam 18 through window 235. Beam 18 is modulated by retromodulator unit 50 with the photograph data and retroreflected back to transceiver unit 10 where it is demodulated and sent for printing.

The total information transferred could attain a storage volume of 20 Megabytes or 160 Megabits, for a 16-picture card, since photographs are often compressed according to JPEG standard, with an average of approximately 1-2 megabytes/frame.

Assuming downloading of the information lasts 3 minutes (which is much shorter than the normal waiting time for delivering a card to a printing service), results in a communication channel of 160/180 kilo bits/second. The modulator should normally operate at a 1 Megabits/sec rate. This can be easily achieved at a low cost, using of the shelf components, by splitting the modulator into 10 parallel channels, each channel operating at a 100 kbits/sec. This can be achieved using state of the art liquid crystal devices. The discrimination between the channels can be achieved by spectral filtration of channels. Another aspect of the present invention is the ability to download the images via the glass window 235 of the photo shop, even when the shop is closed.

In an alternative embodiment of the same application, transceiver unit 10 is connected to a home or office computer. Camera 230 can be anywhere in the same room. Transceiver unit 10 detects the presence of camera 230 and queries camera 230, causing camera 230 to download its stored photographs via retromodulator unit 50. The process may take a few hours on an automatic basis. In that case, assuming downloading the information within 1 hour, the information bandwidth is 10-20 times slower than in the former case, which means a retromodulator bandwidth of 50-100 kbits/sec with a single channel.

It should be appreciated that had the photos been downloaded via wire, such as via USB connection, instead of by retroreflection, the camera batteries would rapidly become depleted.

Another preferred embodiment of the present invention implements data producer as a remote identification tag and data consumer as a media system.

In this embodiment, a tiny retromodulator unit 50 is attached as a remote identification tag to a person whom it is wished to be able to quickly and automatically identify or monitor. Such a person could be a soccer player who is shown on video during the broadcast of a soccer match. Transceiver unit 10 is mounted on an identification media, such as a video camera and transmits in a direction parallel to the camera viewing direction. There is an interest to immediately and automatically display the name of the soccer star so that the TV spectators know who is seen on the screen. By permanently modulating the retromodulator with the player name, the camera/transceiver system can automatically identify and display the name of the player. That technique is useful also in broadcasting sport activities in Olympic Games, to identify people in crowded places for security purposes, and many other implementations.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. A data communication system comprising a transceiver unit for retromodulated optical communication with at least one of a plurality of retromodulator units, the transceiver unit comprising at least one of a plurality of transceivers, the transceivers transmitting diffused radiant energy at different angles covering a predetermined three-dimensional area, wherein each transceiver is enabled to set up and execute communication with at least one retromodulator unit located within its coverage area.

2. The system of claim 1 where the coverage areas are contiguous.

3. The system of claim 2 where the coverage areas overlap.

4. The system of claim 1 wherein each transceiver is further enabled to maintain continuous communication with a retromodulator unit that moves between coverage areas.

5. The system of claim 1 further comprising at least one of a plurality of retromodulator units, where the retromodulator unit comprises multiple arrays of lenslets connected to a common modulator and reflector.

6. The system of claim 1 where the retromodulator unit comprises a spherical arrangement of lenslets connected to a common modulator and reflector.

7. The system of claim 5 where the retromodulator unit is provided with an interface for communication with a data processing device.

8. The system of claim 1 further comprising at least one of a plurality of retromodulator units, where the retromodulator unit comprises two or more parts, each part comprising a narrow band-pass optical filter and a modulator, each part communicating with a separate segment of the transceiver unit.

9. The system of claim 1, wherein the transceiver unit is configured to transmit low level radiation until detection of a retromodulator unit, whereupon the radiation level is increased in the transceiver covering the predetermined three-dimensional area in which the detected retromodulator unit is located.

10. The system of claim 9 where detection of the retromodulator unit is triggered by retroflected radiation from the retromodulator unit received by the transceiver unit.

11. The system of claim 9 where detection of the retromodulator unit is triggered by retromodulated radiation from the retromodulator unit received by the transceiver unit.

12. The system of claim 1 where the radiant energy is transmitted and received via an optical fiber.

13. The system of claim 1 where the radiant energy is modulated at a high frequency.

14. The system of claim 1 wherein the retromodulator unit is integrated into a remote control and communicates control data to the transceiver unit, which is integrated into a device controlled by the remote control.

15. The system of claim 14 where the remote control further comprises one or more photovoltaic cells.

16. The system of claim 15 where the remote control further comprises a battery charger.

17. The system of claim 1 wherein the retromodulator unit is integrated into an electronic remote identification card and the transceiver unit is implemented in an access control point.

18. The system of claim 17 further comprising analyzing components for comparing biometric information permanently stored in the card with real-time biometric information obtained from the card owner.

19. The system of claim 18 where the real-time biometric information obtained from the card owner is sent to the transceiver unit via the retromodulator.

20. The system of claim 1 wherein the retromodulator unit is integrated into a micro aerial vehicle and the transceiver unit is a data collection station.

21. The system of claim 1 wherein the transceiver unit is integrated into a microaerial vehicle and the retromodulator unit is a remote sensor.

22. The system of claim 12 where the transceiver unit is integrated into a data collection station and the retromodulator unit is a remote sensor.

23. The system of claim 22 where the remote sensors are installed internally along the length of a pipe.

24. The system of claim 12 where the transceiver unit is integrated into a data collection station and the retromodulator unit is a remote sensor that detects intruders.

25. The system of claim 1 where the transceiver unit is integrated into a photographic printing service and the retromodulator unit is integrated into a camera.

26. The system of claim 1 where the transceiver unit is integrated into a personal computer and the retromodulator unit is integrated into a camera.

27. The system of claim 1 where the transceiver unit is integrated into a media system and the retromodulator unit is integrated into remote identification tag.

28. A method for retromodulated data communication, the method comprising:
providing a transceiver unit comprising at least one of a plurality of transceivers;
transmitting diffused radiant energy through the transceivers at different angles covering a predetermined three-dimensional area;
setting up communication between a transceiver and a retromodulator unit located within the coverage area of that transceiver;
executing the communication between the transceiver and the retromodulator unit.

29. The method of claim 28 where setting up communication comprises:
a retromodulator in a transceiver's area of coverage retroflecting the radiant energy;
the transceiver responding to the retroflection by increasing the power of the radiant energy;
the retromodulator responding to the higher power by initiating data modulation of the radiant energy.

30. The method of claim 28 where setting up communication comprises:
a retromodulator in a transceiver's area of coverage retromodulating the radiant energy with an initial handshake signal;
the transceiver responding to the retromodulation by increasing the power of the radiant energy;
the retromodulator responding to the higher power by initiating data modulation of the radiant energy.
